(19) United States
(12) Patent Application Publication
(10) Pub. No.: US 2012/0186536 A1
(43) Pub. Date: Jul. 26, 2012

(54) Predation Deterrence

(76) Inventor: Jonathan Leslie Charles Hall, Packington (GB)

(21) Appl. No.: 13/381,981

(22) PCT Filed: Aug. 4, 2010
(86) PCT No.: PCT/GB2010/001470

§ 371 Date: Apr. 10, 2012

(30) Foreign Application Priority Data
Aug. 6, 2009 (GB) 0913708.4

(51) Int. Cl. A01K 15/02; A01K 27/00

(52) U.S. Cl. 119/719; 119/859

(57) ABSTRACT

A cat's collar has mounted on it a device (10) which incorporates an accelerometer (15), a microprocessor (16), a battery (14) and a loudspeaker (12). The accelerometer (15) constantly monitors the position of the cat's head relative to its spine. When the cat's head ceases to move up and down and from side to side while the cat is moving forward, the cat is in stalking mode, and the microprocessor actuates an audible alarm to warn the intended prey.

This invention relates to a device for deterring predation, and more specifically to a device for deterring the predation of birds by domestic cats.

The predation of birds by domestic cats is a serious problem and a cause of distress to many cat owners. In the past cats were employed to keep down mice and other vermin so that a device which alerted their prey would not have been generally welcomed. Nowadays, however, vermin are under control by other means and it is unnecessary to allow domestic cats to catch prey. Many species of song birds are under threat and domestic cats present a particular danger because although well-fed and consequently fit their instinct to hunt is undiminished. It has been estimated that in the United Kingdom alone 75 million song birds fall victim to domestic cats every year.

The present invention proceeds from the observation that domestic cats undergo unique physical configurations preparatory to making a kill. The cat crouches, stiffens its spine and focuses on the prey. The relationship between the head and the spine becomes fixed and the cat does not exhibit the usual “bobbing” of the head as seen when a cat walks normally. It then moves slowly toward the prey attempting to gain an advantageous position in closer proximity to the prey. As the cat moves toward its target its gaze is fixed on the prey eliminating almost all side to side and up and down movement of the head.

These behavioural differences are illustrated by FIG. 3 of the accompanying drawings. As the cat moves forward from left to right in its normal gait the line I illustrates a vertical elevation of how its head bobs up and down. The line II illustrates a view from above of how the cat's head moves from side to side. In the section (a) the cat is looking left, in the section (b) it is looking ahead, in the section (c) it is looking to its right, in the section (d) it is looking ahead again, in the section (e) it is looking further to its right than in section (c) and in the section (f) it is looking ahead again. The lines III and IV are comparable views illustrating the relationship of the cat's head to its spine when in “stalking” mode. As will be apparent there is virtually no movement of the head either up and down or side to side.

The device of the present invention utilises an accelerometer which can detect movement or the lack of movement in three angularly related axes, X, Y and Z. The orientation of the accelerometer on a cat's collar is immaterial as it uses gravity to establish the Z, vertical axis. It is adapted to sense movement in the X, forward direction and a reduction of movement in the Y, horizontal axis and Z, vertical axis. A microprocessor connected to the accelerometer responds, by sounding an alarm, to a combination of signals indicating that the cat is at the same time moving forward and that it has ceased to move its head, or move it to the normal extent, both up and down and from side to side. To reduce the possibility of false alarms the microprocessor does not actuate the alarm until the cat has moved forward (X axis) a predetermined distance, e.g. 50 cm to 90 cm.

Inevitably in some rare instances the alarm will be triggered inappropriately. However if the alarm is not too loud or unpleasant it will not annoy either the cat or any humans in the vicinity. An alarm particularly favoured would be the distress call of a bird, such as a is blackbird. Birds will be especially sensitive to such a sound.

In accordance with the present invention there is provided a device for deterring predation by an animal wearing the device, the device comprising means for detecting a combination of forward movement of the animal and a reduction in movement of the animal's head both up and down and from side to side and means for actuating an alarm when the said predetermined criteria exist.

In a preferred embodiment of the invention the device is adapted to be mounted on a cat's collar.

The device may comprise a base and a loudspeaker unit in a separated relationship such that the collar can be threaded between them, the base incorporating the detecting means, the alarm actuating means and a power supply.

The said detecting means is preferably an accelerometer adapted to detect movement in three orthogonally related axes.

Preferably the accelerometer is adapted to detect gravity in order to establish a vertical Z axis.

The said means for actuating an alarm is preferably a microprocessor which receives signals from the accelerometer and actuates the alarm when the accelerometer has detected simultaneously forward movement and a reduction of up and down and side to side movement.

Preferbly the microprocessor is adapted not to actuate the alarm until forward movement of a predetermined extent has been detected.

The alarm is preferably an audible alarm which imitates the alarm call of a bird, preferably a blackbird.

The device may incorporate a switch which switches the device on or off as the animal passes through a cat-flap or similar dedicated portal suitably equipped with means for actuating the said switch.

The device may incorporate a photoelectric cell which will switch the device off in the absence of light.

A preferred embodiment of the invention will now be described by way of non-limitative example with reference to the accompanying drawings, in which:

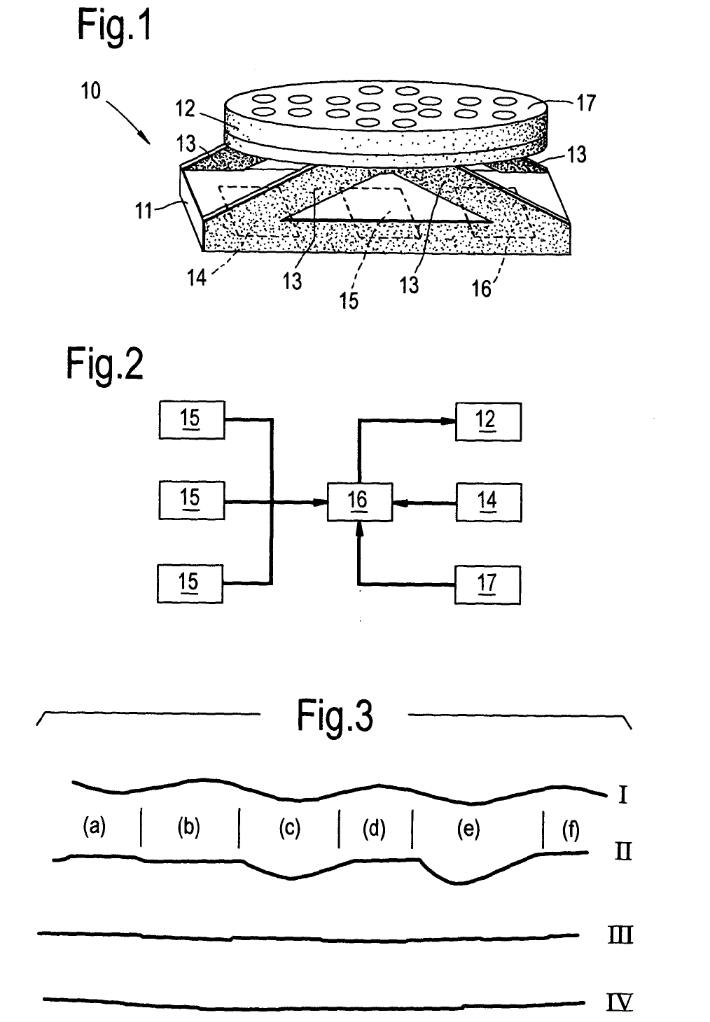

FIG. 1 illustrates a device to be attached to the collar of a domestic cat;

FIG. 2 is a circuit diagram illustrating the interaction of the different components incorporated in the device of FIG. 1, and

FIG. 3 illustrates a comparison between the relationship of a cat's head to its spine during normal walking movement (lines I and II) and when stalking a prey (lines III and IV).

The device 10 illustrated comprises a base 11 and a loudspeaker unit 12 separated by four struts 13. The struts provide a slot or tunnel between the base 11 and the loudspeaker unit 12 through which a cat's collar (not shown) can be threaded to mount the device 10 on the collar in such a way that it is unlikely to fall off. Within the base 11 are a battery 14, an accelerometer 15 and a microprocessor 16. The battery 14 powers the microprocessor 16 and the accelerometer 15.

Referring to FIG. 2, when the battery 14 is switched on the accelerometer 15 constantly monitors its movement forward (X axis), from side to side (Y axis) and up and down (Z axis). The Z axis is determined by the detection of gravity and so is independent of the position of the device 10 around the collar. When signals are received by the microprocessor indicating that the accelerometer has moved a predetermined distance along the X axis and that simultaneously its movements along the Y and Z axes have diminished the microprocessor energises the loudspeaker 12 to emit an audible alarm.

One of the necessary signals is of movement along the X axis so that the alarm will not be triggered if the cat simply lies down.

The alarm could be visual instead of or as well as audible. The most favoured alarm sound would be that of the distress or alarm call of a bird, especially that of a blackbird. This will not unduly discomfit the cat, or humans in the vicinity, but will alert birds to the presence of the cat even if not particularly loud.

To prevent the alarm being accidentally triggered while the cat is indoors it could be controlled by a switch (not shown) which is switched on or off as the cat passes through a cat flap. This could be achieved by induction, magnetically or by the use of radio or the breaking of an infra red beam. The alarm would be switched off as the cat entered the house and on as it exited.

The device 10 may incorporate a photoelectric cell 17 which will switch off the battery 14 in the absence of light so that the device does not function at night.

1-10. (canceled)

11. A device for deterring predation by an animal wearing the device, the device comprising apparatus for detecting forward movement of the animal and apparatus for actuating an alarm, characterized in that there is additionally provided apparatus for detecting a reduction in movement of the animal's head both up and down and from side to side, the arrangement being such that the alarm is actuated only when there is, in combination, forward movement of the animal and a reduction in the movement of the animal's head both up and down and from side to side.

12. A device as claimed in claim 11 adapted to be mounted on a cat's collar.

13. A device as claimed in claim 12 further comprising a base and a loudspeaker unit in a separated relationship such that the collar can be threaded between them, the base incorporating the apparatus for detecting, the apparatus for actuating an alarm and a power supply.

14. A device as claimed in claim 11, wherein said apparatus for detecting is an accelerometer adapted to detect movement in three orthogonally related axes.

15. A device as claimed in claim 14, wherein the accelerometer is adapted to detect gravity in order to establish a vertical axis.

16. A device as claimed in claim 11, wherein said apparatus for actuating an alarm is a microprocessor which receives signals from the apparatus for detecting and actuates the alarm when the apparatus for detecting has detected simultaneously forward movement and a reduction of up and down and side to side movement.

17. A device as claimed in claim 16, wherein the microprocessor is adapted not to actuate the alarm until forward movement of a predetermined extent has been detected.

18. A device as claimed in claim 11, wherein the alarm is an audible alarm which imitates the alarm call of a bird.

19. A device as claimed in claim 11 incorporating a switch which switches the device on or off as the animal passes through a cat-flap or similar dedicated portal suitably equipped with an apparatus for actuating the said switch.

20. A device as claimed in claim 11 incorporating a photoelectric cell which will switch the device off in the absence of light.

21. A device for combating predatory tendencies in animals comprising:
a collar adapted to be worn by an animal, said collar including one or more housings;
said one or more housings containing:
a processor;
an alarm device under control of said processor;
an accelerometer in electrical communication with said processor;
wherein, said processor contains an executable program adapted to activate said alarm device when said accelerometer indicates both forward movement of the animal and a reduction in the movement of the animal's head both up and down and from side to side.

22. The device of claim 21 wherein the accelerometer is adapted to detect movement in three orthogonally related axes.

23. The device of claim 21 wherein the accelerometer also detects gravity.

24. The device of claim 21 wherein said executable program is adapted not to actuate the alarm until forward movement of a predetermined extent has been detected.

25. The device of claim 21 further including a switch which switches the device on or off as the animal passes through a cat-flap or similar dedicated portal suitably equipped with an apparatus for actuating the said switch.

26. A method for controlling predatory tendencies in an animal comprising:
providing a collar adapted to be worn by an animal, said collar including one or more housings attached to said collar;
wherein said one or more housings contain:
a processor;
an alarm device under control of said processor;
an accelerometer in electrical communication with said processor;
providing an executable program running on said processor adapted to activate said alarm device when said accelerometer indicates both forward movement of the animal and a reduction in the movement of the animal's head both up and down and from side to side.

27. The method of claim 26 further comprising not allowing said alarm to actuate until forward movement of a predetermined extent has been detected.

28. The method of claim 26 further comprising causing said alarm device to produce an audible alarm that imitates the alarm call of a [symbol]
